(19) United States
(12) Patent Application Publication
(10) Pub. No.: US 2010/0307007 A1
(43) Pub. Date: Dec. 9, 2010

(54) Stripping Tool

(75) Inventor: Heinrich Grosserichter, Ascheberg (DE)

Correspondence Address: LERNER GREENBERG STEMER LLP, P O BOX 2480, HOLLYWOOD, FL, 33022-2480, US

(73) Assignee: KRAMPE IMMOBILIEN GMBH & CO. KG, Ascheberg (DE)

(21) Appl. No.: 12/779,370

(22) Filed: May 13, 2010

(30) Foreign Application Priority Data
Jun. 3, 2009 (DE) 10 2009 025 908.2

(51) Int. Cl. H02G 1/12

(52) U.S. Cl. 30/90.6

(57) ABSTRACT

A stripping tool removes the insulation on single-wire or multi-wire cables with two jaws, which are connected by common hinge axels to form a hollow body which can be opened for inserting a cable that is to be stripped. Near the ends of the jaws are fitted blades for a circular cut, and opposite of the blades, at the other end of the hinge axel, is fitted with a slitting knife situated in a guiding groove that is oriented diagonally in the hollow body. Recesses are formed in the longitudinal edges closing the hollow body, that, when the tool is closed, a cable to be cut longitudinally is guided in through the hollow body, by the guiding groove and the recesses, that it is neatly guided in the guiding groove along the slitting knife for the longitudinal cut without the need to additionally guide the cable with one's fingers.

### CROSS-REFERENCE TO RELATED APPLICATION

This application claims the priority, under 35 U.S.C. §119, of German application DE 10 2009 025 908.2, filed Jun. 3, 2009; the prior application is herewith incorporated by reference in its entirety.

### BACKGROUND OF THE INVENTION

### Field of the Invention

The invention relates to a stripping tool for removing insulation on single-wire or multi-wire cables with two jaws, which are connected by common hinge axes to form a hollow body which can be opened for inserting a cable that is to be stripped, and which near their ends are fitted with blades for a circular cut, and which, opposite of the blades, at the other end of the hinge axis, are fitted with a slitting knife situated in a guiding groove that is oriented diagonally in the hollow body.

A stripper for removing the insulating sheath of cables is known from German utility model DE 298 14 771 U1, which has two jaws, which are connected via common hinge axes to form a hollow body which can be opened for inserting a cable that is to be stripped, and which near their ends present blades for a circular cut. It is not intended to slit the cable sheath longitudinally.

The stripping tool according to U.S. Pat. No. 5,653,027 contains a slitting knife for cutting the cable sheath longitudinally. The cable is held with a bracket and is not guided in any other way.

In the stripper pliers according to British patent application GB 2 181 986, a slitting knife is provided in a short guide through which the cable can be drawn.

The tool according to published, non-prosecuted German patent application DE 38 08 950 A1 has a hollow body with two jaws and provides a stripping device for cable wires. The device has knife blades that are mounted in such a way that they protrude at the outside of the jaws and overlap when the jaws are moved towards each other. Furthermore, inside the hollow body a slitting knife is provided, which allows one to cut the cable sheath longitudinally.

When put into use, the tool has not proven very convenient. The knife for longitudinal cutting arranged at one end at the inside of the hollow body caused problems with precise cutting. The cable end is inserted into the hollow body and then the jaws are folded up. It is now necessary to firmly press with one's fingers the cable that is to be pulled out against the jaw end with the knife for the longitudinal cut. If this is not done with care, the cut is not always straight along the axis of the tool and the sheath of the cable is not split neatly. Also, the cutting process requires more effort than necessary.

Secondly, when the hollow body is open, the knife for the longitudinal cut stands out unprotected from the inside, so there is a risk of injuring one's fingers.

A further development of the stripping tool described above is the Super-Stripper No. 15 (Article No. 30150) of the company JOKARI, the description of which can be found on the internet at: http://www.jokari.de/produkte/techmanuals/jokari_entmantler15.pdf. The cable is guided longitudinally inside the tool, so that the cable has to be guided with one's fingers.

A very thin wire is guided in a similar way in the cutting tool according to U.S. Pat. No. 4,741,104. The cable is guided centrally inside the tool.

### SUMMARY OF THE INVENTION

It is accordingly an object of the invention to provide a stripping tool which overcomes the above-mentioned disadvantages of the prior art devices of this general type, which has a different arrangement of the knife for providing the longitudinal cut.

With the foregoing and other objects in view there is provided, in accordance with the invention a stripping tool for removing insulation on single-wire cables or multi-wire cables. The striping tool contains blades, common hinge axels, and two jaws connected by the common hinge axels to form a hollow body which can be opened for inserting a cable that is to be stripped. The blades are disposed near an end of one of the common hinge axels for performing a circular cut on the cable. The hollow body has a guiding groove that is oriented diagonally in the hollow body. The hollow body has longitudinal edges with recesses and the longitudinal edges close off the hollow body. A slitting knife is disposed opposite the blades, at an end of another one of the common hinge axels. The slitting knife is disposed in the guiding groove and when the stripping tool is closed, the cable that is to be cut longitudinally is guided in such a way through the hollow body, by the guiding groove and the recesses, that the cable is guided in the guiding groove along the slitting knife for the longitudinal cut without a need to additionally guide the cable with one's fingers.

In a stripping tool according to the invention, the cable that is to be provided with the longitudinal cut is guided by the guiding groove in the hollow body and the recesses in the longitudinal sides of the jaws of the stripping tool. The cable is drawn through the closed tool diagonally and thus neatly guided along the knife for the longitudinal cut in the guiding groove, without further need to be guided by one's fingers. The longitudinal cut is straight with an even depth.

Other features which are considered as characteristic for the invention are set forth in the appended claims.

Although the invention is illustrated and described herein as embodied in a stripping tool, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 a diagrammatic, top, plan view of a stripping tool in its open position according to the invention;

FIG. 2 a front view of the stripping tool in the open position; and

FIG. 3 a sectional view of the stripping tool with a cable inserted in the tool.

### DETAILED DESCRIPTION OF THE INVENTION

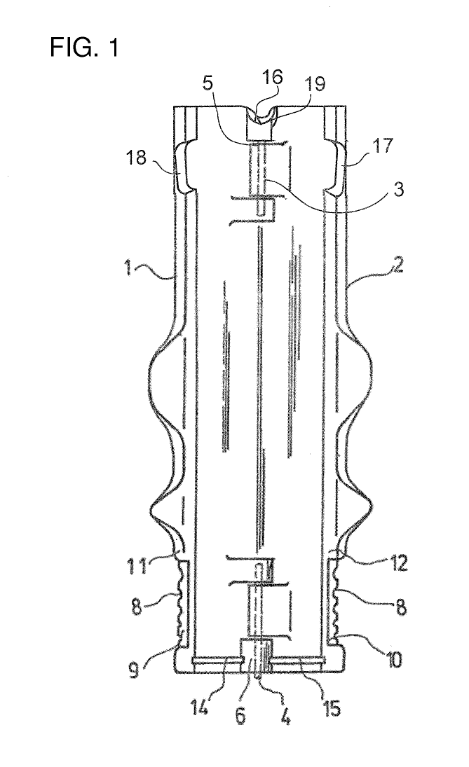

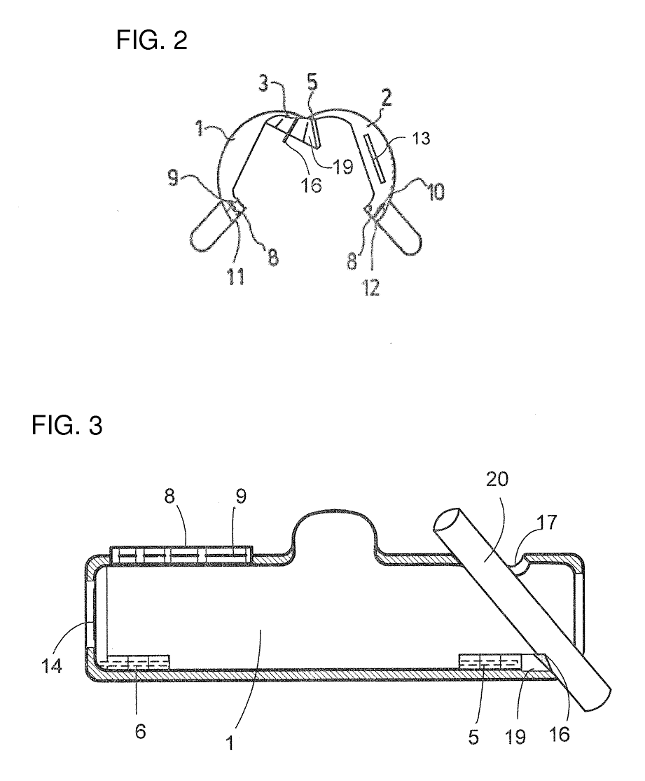

Referring now to the figures of the drawing in detail and first, particularly, to FIGS. 1, 2 and 3 thereof, there is shown a basic form of a stripping tool. The jaws 1, 2 have a cross section of a partial cylinder and their adjacent sides are connected by hinge axels 3, 4 in a form of hinges 5, 6. The jaws 1, 2 are folded at the hinge axels 3, 4 to form a hollow body. A profile knife with recesses 8, which consists of two symmetrical halves 9, 10, is provided at longitudinal edges 11, 12 of the jaws 1, 2. The halves are located exactly opposite each other at the longitudinal edges closing the hollow body extending parallel to the hinge axels 3, 4.

To expose the wires, it is necessary to remove the outer insulation of the cable. The stripping tool according to the invention is a multi-purpose tool, which for this purpose possesses blades 14, 15 directly at the front side of the jaws 1, 2. The blades 14, 15 perform a circular cut on a cable located inside the hollow body with the jaws 1, 2 closed, when the stripping tool is turned around the cable core. Subsequently, a longitudinal cut is required to completely remove the outer insulation. For this purpose, the stripping tool according to the invention is additionally equipped with a slitting knife 16. It is located at the back side of the jaws 1, 2 opposed to the blades 14, 15 opposite and is arranged next to the hinge axel 3 on a guiding groove 19, with its cutting edge protruding freely into the hollow body, vertical to its axis.

When executing the longitudinal cut, a cable 20 is taken from the jaws 1, 2 after opening them, and is then put back into the jaws 1, 2, at recesses 17, 18 which guide the cable. When the cable 20 is pulled, the slitting knife 16 penetrates the insulation and when the cable 20 is pulled out, the slitting knife 16 performs the longitudinal cut. It does not matter which cut is executed first, but it might be appropriate to carry out the circular cut first, because this way it is easier to exactly define the length of the insulation sheath that is to be removed. It goes without saying that instead of rotating the cable 180°, the stripping tool can be rotated as well.

The arrangement of the slitting knife 16 on the guiding groove 19 ensures that the cut in the insulation can be executed neatly, virtually parallel to the cable core or to the axis of the tool with minimal effort.

In the described embodiment, the stripping tool is an unproblematic multi-purpose-tool, which can successively remove the outer insulation of a cable by circular and longitudinal cuts, while no specific guidance with one's fingers is required.

1. A stripping tool for removing insulation on one of single-wire cables and multi-wire cables, the striping tool comprising:
blades;
common hinge axels;
two jaws connected by said common hinge axels to form a hollow body which can be opened for inserting a cable that is to be stripped, said blades are disposed near an end of one of said common hinge axels for performing a circular cut on the cable, said hollow body having a guiding groove formed therein and oriented diagonally in said hollow body, said hollow body having longitudinal edges with recesses formed therein, said longitudinal edges closing said hollow body; and
a slitting knife disposed opposite said blades, at an end of another one of said common hinge axels, said slitting knife disposed in said guiding groove and when the stripping tool is closed, the cable that is to be cut longitudinally is guided in such a way through said hollow body, by means of said guiding groove and said recesses, that the cable is guided in said guiding groove along said slitting knife for the longitudinal cut without a need to additionally guide the cable with one's fingers.

2. The stripping tool according to claim 1, wherein for the longitudinal cut, the cable is passed through said hollow body at an angle of approximately 45°.

3. The stripping tool according to claim 1, wherein said guiding groove has a radius of about 5 mm.

4. The stripping tool according to claim 1, wherein said slitting knife protrudes about 1 mm from said guiding groove.
